(19) United States
(12) Patent Application Publication
(10) Pub. No.: US 2003/0150394 A1
(43) Pub. Date: Aug. 14, 2003

(54) Self-contained tropical rainforest vivarium system

(76) Inventor: Jared Wolfe, Calgary (CA)

Correspondence Address: ILYA ZBOROVSKY, 6 Schoolhouse Way, Dix Hills, NY, 11746, US

(21) Appl. No.: 10/073,073

(22) Filed: Feb. 12, 2002

(51) Int. Cl. A01G 9/02; A01K 63/00

(52) U.S. Cl. 119/246

(57) ABSTRACT

A self contained tropical rainforest vivarium system has an enclosure and a system for creating and maintaining environmental conditions found in a natural tropical rainforest habitat, which at the same time eliminate unnecessary build-up of anaerobic bacteria so as to prevent accumulation of stench and resulting need for frequent disassembly for cleaning and removal of the bacteria and contaminants.

### BACKGROUND OF THE INVENTION

The present invention generally relates to vivarium systems.

More particularly, it proposes a self-contained tropical rainforest vivarium system.

Vivarium systems are generally known in the art. In the known vivarium systems there is an enclosure which accommodates corresponding devices to create certain vivarium conditions inside the enclosure. However, these devices are not designed to produce tropical rainforest conditions inside a vivarium and maintain them automatically as well as to control them by a user. It is therefore believed to be clear that the existing vivarium systems can be further improved in these aspects.

### SUMMARY OF THE INVENTION

Accordingly, it is an object of the present invention to provide a self contained tropical rainforest vivarium system which avoids the disadvantages of the prior art and which creates and maintains conditions which are typical for a tropical rain forest.

It is also an object of the present invention to allow a continual flow of fresh oxygen to the system, in a manner that prevents stagnation of the said enclosed environments air, substrate and water supply, providing an ultra-low maintenance system that has a continually fresh smell of a lush tropical rainforest.

It is also an objective of this present invention to provide a vivarium system that can effectively replicate the self-filtration and waste removal as does exist in natural rainforest environments, by use of plants that are irrigated to effectively and naturally remove the waste of any faunal vivarium residents, including amphibians and reptiles.

It is also an objective of this present invention to provide an aquarium-vivarium system that can effectively replicate the self-filtration and waste removal as does exist in natural rainforest environments, by use of plants situated on vertical substrate panels that are irrigated to effectively and naturally remove the waste of any faunal vivarium residents, including fish, amphibians and reptiles.

It is also an objective of this present invention to provide a means to reduce the maintenance requirements of a rainforest vivarium, to integrate the system with a water supply to avoid the tiresome need to continually fill the water supply. This will enable a practical method to maintain humidity within a home or office environment with the system adjusted to use enough water to humidify the room or area it is placed in.

It is another objective of this system to provide an aquarium-rainforest vivarium system that replicates the pristine and non-stagnating conditions of a natural tropical rainforest.

It is another objective of this present invention to provide an aquarium-vivarium system where the water level remains constant within the system, to relieve disruption of the system and its inhabitants.

It is anther objective of the present invention to replicate non-stagnating conditions of a natural tropical rainforest.

It is another objective of the present invention to prevent the escape of any organism, vertebrate or invertebrate, with a diameter larger than 1 mm when the system access doors are closed.

It is also an objective of the present invention to incorporate a specialized passive ventilation system, which allows the user to adjust the humidity level within the vivarium, increasing the versatility of the said invention in different outside environments.

It is also an object of the present invention to provide a vivarium and aqua-vivarium system where the viewing suface remains unobstructed by condensation.

It is a main objective of the present invention to provide a means by which a natural biotope can be replicated to include the finite changes in environmental conditions on an hourly, daily and yearly basis, throughout the various unique hidden microclimates it contains, and to shelter and support life as it is supported in nature.

In keeping with these objects and with others which will become apparent hereinafter, one feature of present invention resides, briefly stated, in a self contained tropical reinforced vivarium system which has an enclosure, and means for creating and maintaining environmental conditions found in a natural tropical rainforest habitat, which at the same time eliminate unnecessary build-up of anaerobic bacteria so as to prevent accumulation of stench and resulting need for frequent disassembly for cleaning and removal of the bacteria and contaminants.

When the vivarium system is designed in accordance with the present invention it provides tropical rainforest conditions inside the enclosure and maintain them as well as well as allows to control them automatically and by a user.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a three-dimensional view of a vivarium in accordance with the present invention;

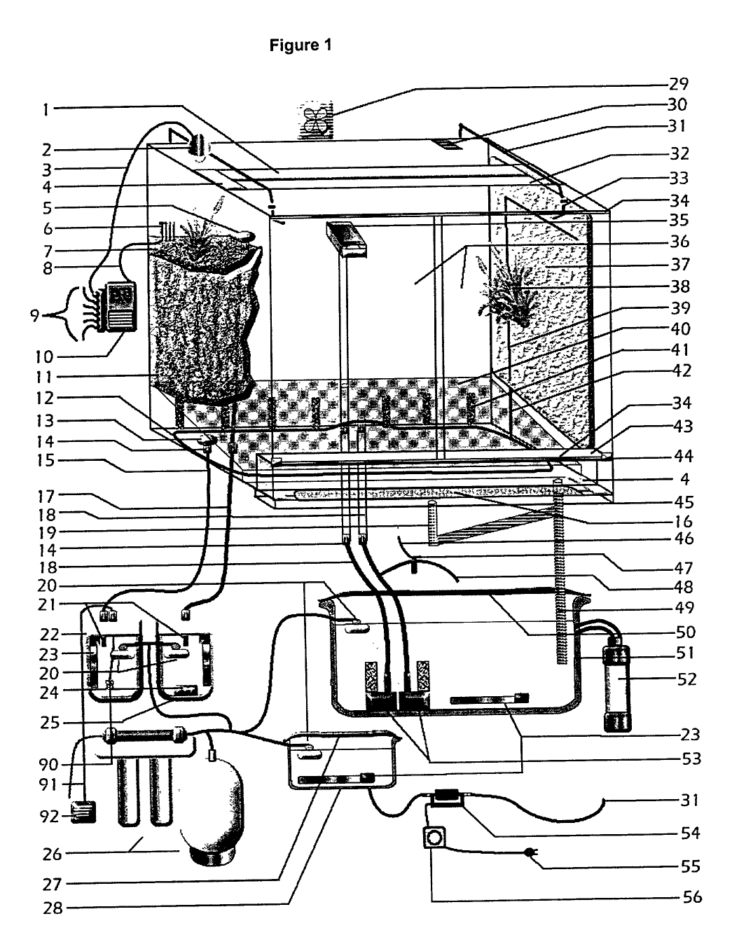

FIG. 2 is a lateral view of a vivarium in accordance with the present invention;

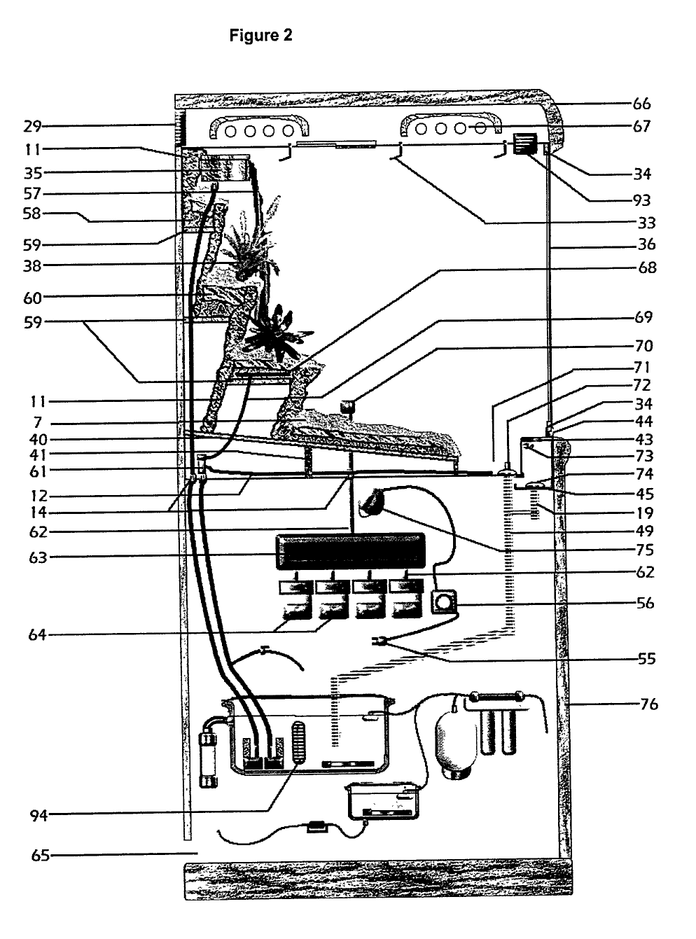

FIG. 3 is a three dimensional view of an aquarium vivarium in accordance with the present invention;

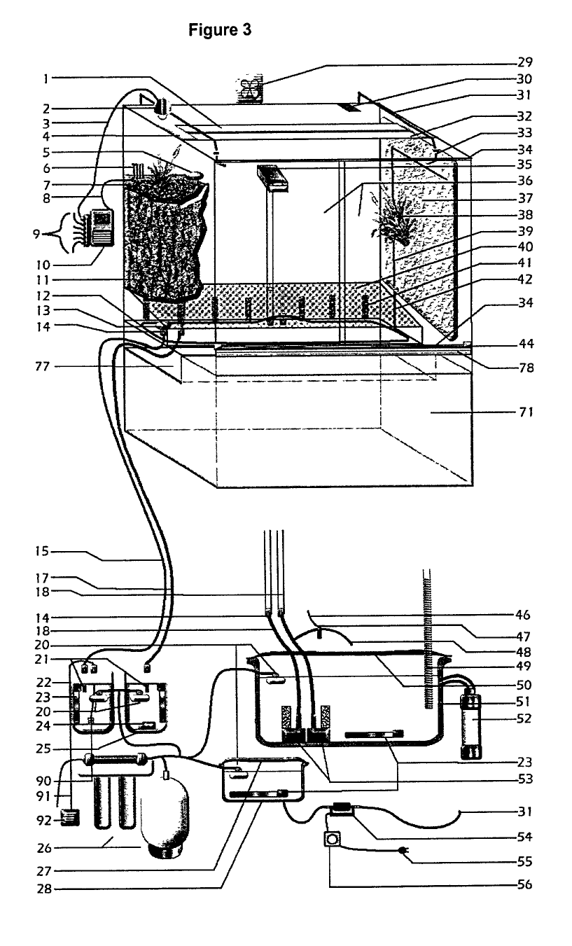

FIG. 4 is a lateral view of the inventive aquarium-vivarium;

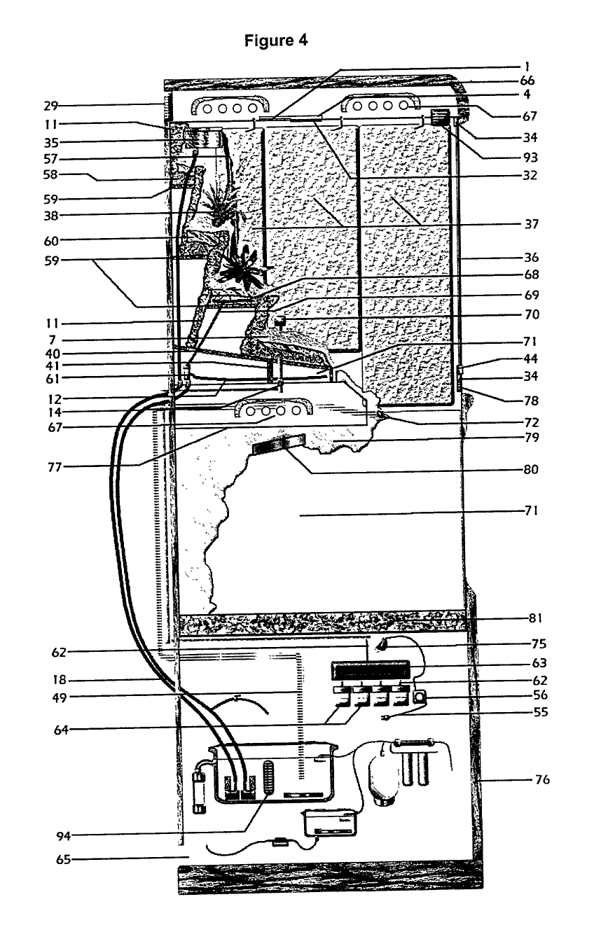

FIG. 5 is a three dimensional view of a living wall in accordance with the present invention;

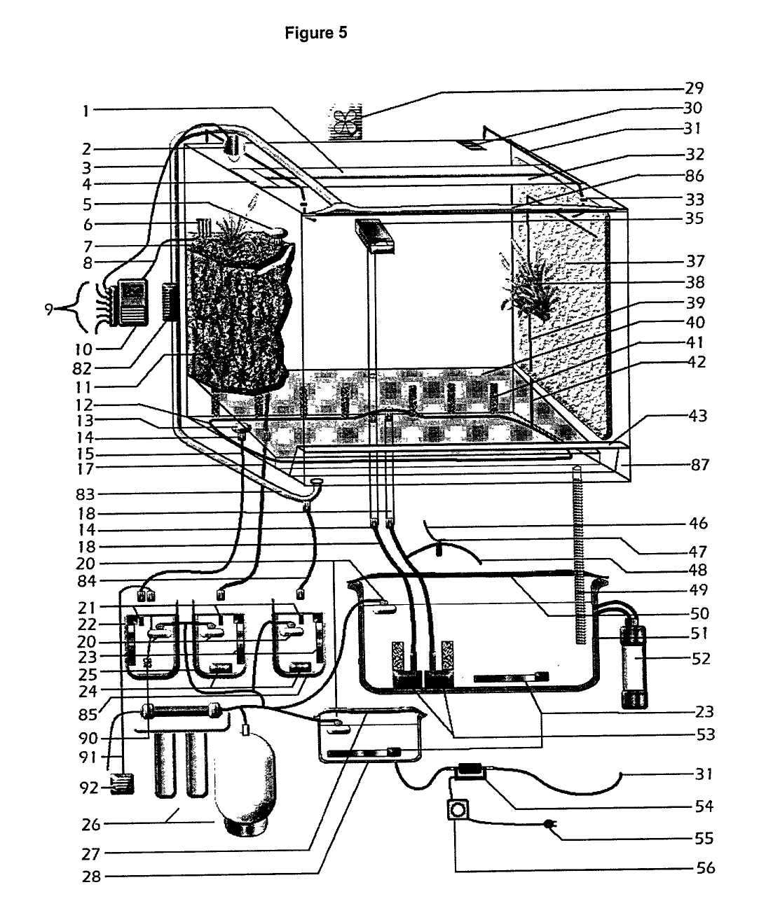

FIG. 6 is a lateral view of the inventive living wall; and

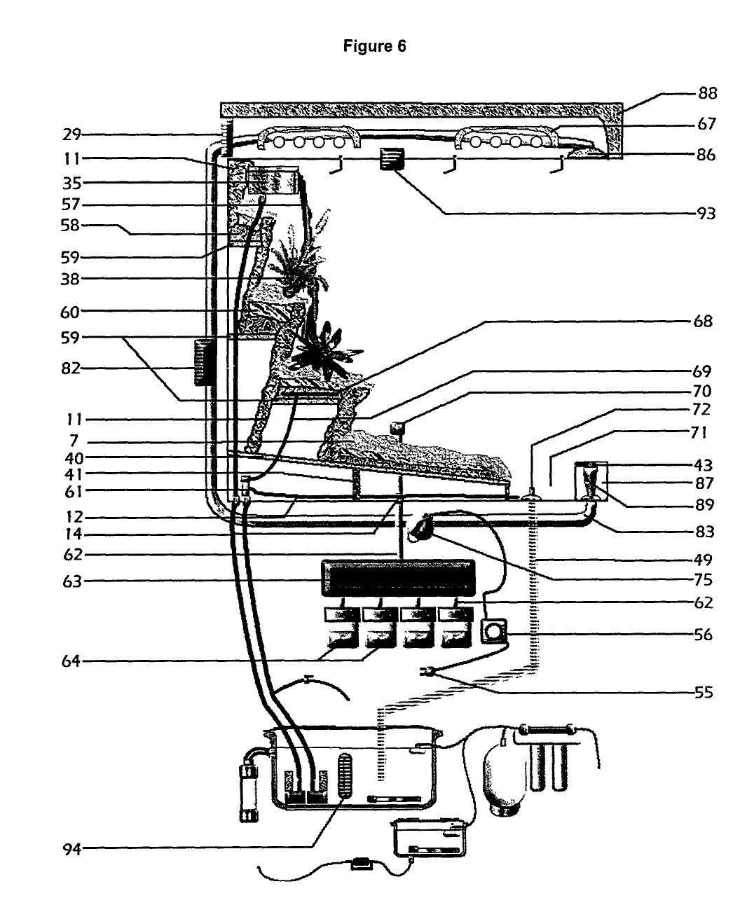

### DESCRIPTION OF THE PREFERRED EMBODIMENTS

A device in accordance with the present invention has an enclosure with a plurality of systems and elements which will be identified herein below. Substantially identical elements shown in different figures of the drawings are identified with the same reference numerals.

The device has a sliding ventilation control plate 1. A localized light is identified with reference numeral 2. The localized light is a specialized light used to mimic a microclimate variation in the vivarium, connected to an environmental control computer. It can include a specialized heat lamp, strobe light, or any other form of lighting. Reference numeral 3 identifies an electric wire. A sliding ventilation control track is identified with reference numeral 4, and a fogging nozzle is identified with reference numeral 5.

The device further has a multiple factor sensor apparatus 6. It can be used to sense various environmental factors, such as light intensity, humidity, temperature, nutrient levels, oxygen and carbon dioxide, which can be used to adjust control over misting, localized lighting, heating, etc., in order to bring the conditions within a pre-programmed range. Multiple sensors can be placed throughout vivarium, especially useful where different microclimates are to be reproduced within the same enclosure. In such a case separate misting, lighting, heating, etc. systems are linked to be controlled by a computer.

The device is provided with a moss layer which is identified with reference numeral 7. It is to be understood that other materials could also be used to cover a substrate. A connecting wire is identified with reference numeral 8. The device further has a circuit control unit 9 for controlling various systems via environmental control computer. Circuits can be formed as simple on/off switches, or complex control over different functions (such as sliding doors, lighting displays, etc.) It provides both power to all electrical devices and full control over their functions. Reference numeral 10 identifies an environmental control computer which is connected to the circuit control unit and to the sensor apparatus. It can include a remote control. The environmental control computer must include a display device. It is programmed to run all connected devices. Data from a natural ecosystem can be loaded in this computer and then it can combine readings from sensors with the data to replicate the environment in the enclosure by adjusting misting, heating, lighting, etc.

A backing material is identified with reference numeral 11. Concealed secondary false bottoms and substrate layers may cover entire rear plate of vivarium and a portion of side plates. The device further has a perforated irrigation tube assembly 12, an aeration nozzle 13, a water tight connection 14 used to connect tubes into the vivarium providing a water tight seal to prevent leakage, an aeration tubing 15, a lower ventilation opening 16, a fogging tube 17, a water feed tubing 18, a ventilation splash guard drainage pipe 19, a flow valve 20, a vapor collection tube 21. A sealed aeration reservoir is identified with reference numeral 22, a submersible water heater is identified with reference numeral 23, an ultrasonic humidifier is identified with reference numeral 24, while a sealed humidifier reservoir is identified with reference numeral 25. A reverse osmosis prefilter 26 is fed from a water supply, with a tubing to feed purified water to float valves in each reservoir.

A misting reservoir lid 27 is arranged on a misting reservoir 28. A ventilation fan is identified with reference numeral 29. The device further has an audio speaker with microchip containing environment sounds, or connected to the main environmental control computer containing a sound library and a program to play various sounds at programmed times.

A misting nozzle feed line is identified with reference numeral 31, an upper ventilation plate is identified with reference numerals 32. A misting nozzle is identified with reference numeral 33, while a sliding glass door track is identified with reference numeral 34 and can be motorized to allow for automatic control over the sliding doors. It can be remotely controlled by the environmental control computer. Reference numeral 35 identifies a waterflow direction control assembly. The device further has a sliding glass door 36, a vertical irrigated plant growth panel 37, with a plant identified with reference numeral 38. A concealed irrigation tubing 39 is provided for a vertical irrigation panel. A primary false bottom 40 is further provided. Reference numeral 41 identifies a wick system. A connective tubing 42 connects the concealed irrigation tubing 39 to an irrigation system. A lower ventilation plate 43 can be heated.

A glass decondensation heating device 44 is further provided. A ventilation splash guard is identified with reference 45. A connection 46 to control device, (either a timer 56 or an environmental control computer 9) in order to provide periodic water drainage by opening or closing the automatic periodic drainage control valve 47. Other elements include a connection to an external drain 48 and a main drainage pipe 49. The device further has a main water reservoir 51 with a main water reservoir lid 50. A water filtration device 52 has an inflow and an outflow tubing from the main water reservoir 51. The device further has a submersible water pump 53 and a misting pump 54. A power supply connection is identified with reference numeral 55. Further, a programmable digital timer 56 is provided. The device has a waterfall 57, an inorganic substrate layer 58, a secondary false bottom 59, an organic substrate layer 60.

An irrigation control valve 61 can be connected to the environmental control computer or to the digital timer to control an irrigation cycle. It is used to divert water to an irrigation tubing located in the organic substrate layer of the secondary false bottom assemblies. It consists of a single valve that is open and closed automatically. A single valve can be connected to the multiple secondary false bottom irrigation assemblies. Multiple valves can be used in situations where watering requirements of various secondary false bottom assemblies within the same environment differ from one another.

An insect transfer tube 62 can be formed as a clear tube that permits the travel of insects from the insect breeding system 63/64 into the vivarium enclosure. This tube can be illuminated to encourage positively phototropic insects to travel out of the insect breeding system. The lighting mechanism may be placed on a timer in order to have specific feeding times, where the light is turned on to promote insect travel into the vivarium. An insect transfer box 63 can be formed as a black container that is suspended below the vivarium and is a place for insects to congregate before travel into the vivarium. This box can contain ventilation screening. It can be removed for cleaning. It is escape proof by means of tight fitting connections. A small odor adsorbing package can be placed in the insect transfer box and can be used to eliminate the subtle odors that can be emitted from the media in the insect breeding containers 64.

The insect breeding container 64 are specialized removable containers with escape proof connections to the insect transfer box 63 via insect transfer tubes 62. These containers are filled with egg laying media and are generally useful for breeding certain insects such as flightless fruit flies or other positively phototropic insects compatible with the system.

A ventilation air intake gap is identified with reference numeral 65. The gap in the construction of the cabinet permits fresh air intake into the system, allowing the flow of air to pass from the bottom of the enclosure to the top. A canopy 66 covers a top portion of the vivarium, hiding the lighting, misting and ventilation components of the system while providing means to direct the light into the vivarium. It also serves to seal off the top and then combine the ventilation fan 29 will allow forced ventilation through the vivarium.

The device further has a light 67. A secondary false bottom irrigation tubing 68 is a tube that is connected to the irrigation system and hydroponically irrigates the inorganic layer of the secondary flow bottom. The flow rate is adjusted by the irrigation control valve 61. A connection tube 69 connects the secondary false bottom irrigation tubing 68 to the irrigation control valve 61. Reference numeral 70 identifies an insect feeding adaptor. It is a small fitting that attaches to the insect transfer tube 62 at the substrate-air interface of the insides of the vivarium. This allows the insect to pass into the vivarium, while preventing passage of vivarium inhabitants back into the insect breeding system 63/64. Water is identified with reference numeral 71, while an overflow valve is identified with reference numeral 72 and maintains a water level in vivarium. It is connected to the main drainage pipe. A heating device 73 serves for providing an even source of heat along the entire length of the lower ventilation plate. This can promote passive airflow through the system, or maintain a constant temperature of air entering the vivarium when forced ventilation is being used.

A ventilation splash guard drainage adaptor 74 is a water tight adaptor connecting element 19 and 45. An insect breeding light 75 is formed as a separate lighting device used to stimulate positively phototropic insects to leave the insect breeding system and to travel into the vivarium. It can be connected to the timer 56 or to the environmental control computer 9 to provide periodic feeding times, as the insects will preferably travel while the light is on.

A cabinet 76 is formed as a rigid structure for holding the vivarium in an elevated position above the floor and to conceal the mechanical elements of the system. The device has an aquarium illumination area identified with reference numeral 77. This is an area forming a part of the glass or the polymer-based basic structure of the aquarium-vivarium, providing a place to store a light used to eliminate the aquatic portion of the structure. It is connected to the side walls of the aquarium vivarium and has at least a top, a front, and a bottom plate, so as to prevent leakage and to allow passage of tubes via watertight fittings through its top plate into the bottom of the upper vivarium part of this system.

An adjustable lower ventilation plate of the aquarium-vivarium 78 is situated in the front of the vivarium and can be adjusted to increase of decrease airflow through it. It also can be heated to adjust the air temperature that passes through it and to increase airflow through the system. An aquarium backing 79 has a backing material that conceals the rear plate of the aquarium and conceals the vivarium aquarium illumination area 77. It can be composed of many different materials, including artificial rock or other molded products, and it must fit securely to all sides of the aquarium back plate and the bottom and front of the element 77. Water can be allowed to pass to the rear of backing 79 by means of small holes to eliminate upward pressure of air that would occur when the aquarium portion is full. Said small holes should be of a diameter that would prevent fish from passing behind backing 79. When water is allowed to pass through the backing, then light is not permitted to illuminate this area.

An aquarium illumination window 80 is formed as a clear plate attached to the element 79 and positioned where light from the aquarium light located in the element 77 can pass into the aquarium, illuminating the aquarium environment. Gravel in the device is identified with reference numeral 81. An air curtain booster fan 82 forces the heated humidified air of the air curtain to flow through the air curtain duct 83, from the collector 86 to the air curtain diffuser 89. An air curtain duct is a heated duct that connects the air curtain collector 86 to the air curtain diffuser, which provides a cyclical flow of heated, humidified air. Thus duct can include an integrated heating system in order to prevent condensation build-up along the walls of the duct.

An air curtain humidification tube 84 connects the sealed humidification chamber 85 to the air curtain duct. The connection is performed by air tight/water tight fittings. The curtain humidification chamber itself is identified with reference numeral 85. It is a sealed unit that provides heated, humidified air to the air curtain assembly. It feeds water by a float valve connected to the reverse osmosis filter, thus maintaining a constant water level with no servicing needs. It contains the heater 23 and the ultrasonic humidifier 24. An air curtain collector 86 is a structure which is located in the upper part of the air curtain. It is a thin strip of material running the entire length of the air curtain table to collect the heated, humidified air and to direct it back into the air curtain duct 83. An air curtain diffuser chamber 87 is a portion of the vivarium structure designed to hide the air curtain diffuser. An air curtain diffuser is connected to the air curtain duct and designed to direct the heated, humidified air from the air curtain duct into a thin, evenly distributed curtain of air, flowing upwards toward the air current collector 86.

The living wall structure can be in an open space instead of against a wall. It can exist without any glass side walls, provided the bottom water is contained as a shallow pool. In such situations the air curtain can exist as a circular structure surrounding the living wall (which will thus serve to contain the environment) with a recollection strip at the top of the structure. In such a design only the air curtain duct would be seen connecting the top collector 86 to the bottom portion of the air curtain system. Conversely, the tube may be attached to waterflow direction control assembly 35, which directs the flow of water into a waterfall.

The device further has a submersible air diffuser 90. This is a structure designed to diffuse the air from the air pump 92 into small bubbles, which allows the air to collect humidity and heat from the water and then to pass out of the sealed aeration reservoir 22. An air line and an air pump are identified with reference numerals 91 and 92. A vivarium air heating and cooling fan 93 is able to heat or cool the vivarium air as required, and may be connected to a temperature sensor that measures the air temperature. The heating and cooling fan 93 may be connected to a programmed computer 10 that will control said fan to duplicate natural diurnal temperature changes. Heating and cooling fan 93 would also have the ability to cool the vivarium air to less than the external air temperature and compensate for excess heat from the lights in the vivarium. A reservoir cooling system 94 is provided that may be connected to a temperature sensor and to computer 10 that could lower the water temperature at a more rapid rate than the provided passive means.

The present invention provides a means to eliminate unnecessary build-up of anaerobic bacteria within the system, causing accumulation of stench and resulting in the need to frequently disassemble the system for cleaning and removal of said bacteria and contaminants. It also makes provision for controlled entry of external air in a manner that regulates a precise simultaneous control over humidity and ventilation and eliminates condensation due to low exterior temperatures.

Because of the highly humid and warm conditions of a rainforest, the invention provides a specific drainage mechanism to keep the substrate aerated and warm.

The invention also provides an exterior water reservoir, to allow for easy water changes, and non-invasive control over the environment, and eliminates the problem with disturbing the tropical flora and fauna within the system to gain access to the waterfall pump and heater, which are typically hidden below the substrate in an area that requires the disruption of the enclosed environment and its inhabitants if the water pump and heater are to be serviced.

The inventive device including an aquarium as a part of a vivarium system accurately recreates the ambient microclimate of a tropical rainforest. It controls aeration of the substrate, and maintains a balance between humidification of the environment and effective control over fresh air intake. It prevents stagnant build-up of anaerobic bacteria, and creates a functional self contained irrigated system, whereby the plants in the vivarium portion of the enclosure effectively remove and filter all waste produced by the aquatic inhabitants of the aquarium portion of the enclosure by means of specialized irrigated panels.

The inventive device has a hidden panel to allow for lighting of the lower aquarium portion of the aquarium-vivarium system.

The outer portion of the rainforest vivarium consists of a environmental regulation and viewing chamber.

The stagnation of air, water and substrate are all addressed by the present invention through a complementary system of precise environmental regulation, with each said component being of significant importance to maintain the delicate balance of a tropical rainforest setting. The items included within the invention to address this necessity are as follows:

(1) Adjustable Passive Ventilation plates located in the bottom front and the upper middle of the enclosure. These plates have a glass or polymer-based panel that is made to slide over the ventilation plate in order to regulate humidity within the controlled rainforest environment. This initiates an airflow in through the bottom vent, which follows up the front viewing surface through the upper ventilation plate. This prevents condensation on the viewing surface, allows fresh intake of air into the system, and provides a method to regulate the environmental conditions within the system based on the exterior environment

(2) These plates may be heated which allows for increased active airflow, necessary for larger vivariums, aquatic vivariums, and vivariums located in cooler surroundings. The ventilation must be designed to eliminate dripping through the ventilation plates as a result of misting and splashing.

(3) Waterfall assembly, consisting of a waterfall fed from a pump located in a lower, externally heated reservoir, which in turn is fed from the overflow valve of the vivarium assembly, thus creating a recirculating aquatic system.

(4) Irrigation/Stagnation assembly, consisting of a perforated tube that provides water in a ring assembly that irrigates the bottom panel of the enclosure, fed from a pump located in an external reservoir, which in turn is fed from the overflow valve of the vivarium assembly, which is part of a recirculating aquatic system. This may be connected to the waterfall pump by use of a separate valve to balance pressure between the waterfall and the irrigation assembly. This feature maintains the ambient temperature of the bottom of the enclosure and aerates to ensure continual flow of all water in the system to prevent stagnation. In addition, the regulated temperature helps to regulate the humidity within the enclosure.

(5) Panel Irrigation assembly, consisting of perforated tube(s) that provide water in 1 or more ring assemblies to irrigate the vertical growth substrate panels of the enclosure, fed from a pump located in an external reservoir, which in turn is fed from the overflow valve of the vivarium assembly, which is part of a recirculating aquatic system. ** Note, the vertical growth panels may be situated at an angle greater than 90 degrees relative to the inside bottom level of the outer Vivarium assembly, in situations where the sides, and or back of the structure are at such angles relative to the bottom.

(6) Active Ventilation/Humidification assembly, Consists of an air pump, that pumps fresh air into a sealed plastic unit, filled with about 80% water with:

Inlet hose attached to a Bubbler

Top outlet hose to collect air, leading out of sealed unit

The outlet hose is passed through watertight holes into the vivarium, and into a perforated tube-ring. This innovation actively aerates the airspace under the false bottom assembly and further humidifies the rainforest vivarium. This assembly further aids in providing adequate oxygen for the root systems of the plants in the vivarium and further enhances the freshness of the enclosed environment. The sealed unit can be attached to a float valve in order to regulate water flow to eliminate the need for water fills as in item.

(7) Misting System, with a pump fed from either a secondary reservoir of fresh water, or an in-line filter assembly located in the lower cabinet, which delivers a controlled misting cycle to the environment to replicate the required rainfall of said habitat. The misting nozzles are situated in the top of the vivarium, and are fed by a tubing apparatus that is suspended by neoprene or other shock absorbing material to limit vibration in case a high pressure unit is used, which is most desirable as this delivers the finest mist to the system. The misting nozzles may be controlled by a small automatic swivel motor that changes the direction of the mist in order to direct said mist in a programmed pattern to different areas of the vivarium. The swivel motor may be connected to computer 10. The mist nozzles may also be designed to deliver different sized rain droplets to imitate forms of precipitation ranging from a mist to heavy rain droplets.

(8) False Bottom Assembly, consisting of a stiff perforated or mesh plate, suspended above the bottom of the Vivarium enclosure, which supports all landmass and substrate within the enclosure, allowing for full drainage through the substrate. For proper operation this false bottom assembly must always have clearance above the water level, and in all assemblies the adjustable overflow valve must be positioned accordingly so the lower water layer does not touch the false bottom assembly. This layer is engineered to support the landmass and generally takes up most of the bottom area of the enclosure. It must include in its structure several support beams that contact the bottom surface of the enclosure, enabling additional strength in supporting the full weight of the landmass without sagging to touch the water layer. The density or size of the beams are proportional to the mass placed upon the false bottom layer. This distance the beam is mounted above the bottom of the enclosure is determined by the desired water depth.

(9) Wick system, consisting of nylon or other fabric, which passively irrigates the substrate situated on top of the false bottom assembly with water fed from the active irrigation perforated tube assembly. This system maintains the temperature of the bottom substrate, and ensures appropriate aeration of the substrate. These are 1 inch wide strips of standard material thickness, and can be situated at varying densities depending on the size and nature of the system. This system is also useful for distributing nutrients from the reservoir to the inorganic and organic substrate layers, feeding the plants located on the bottom of the Vivarium assembly.

(10) Secondary False Bottom Assemblies, which consists of suspended stiff perforated or mesh plates suspended at levels from 6 to 10 inches below the lip of the decor-type plateaus located throughout the vivarium system, to allow drainage through the upper suspended levels of substrate.

(11) Substrate/false bottom interface. A layer consisting of 75 to 100% porous inorganic matter that is layered on top of both primary and secondary false bottom assemblies where organic substrate is to be layered upon. This is to prevent rot and or early degradation of the organic layer, which otherwise will occur if organic substrate is situated directly on top of false bottom assembly. The inorganic layer typically consists of Light Expanded Clay Aggregate (LECA) or other light porous inorganic material such as volcanic rock.

(12) Organic Substrate. This organic layer which is placed on top of all inorganic material as described in typically consists of varying mixtures of the following substances: orchid bark, charcoal, volcanic rock, sand, organic soil, peat moss, palm bark, coconut husk.

(13) Decondensation glass heating elements. Small hidden electric attachments that contact the glass viewing surfaces and heat them gently, stopping condensation and obstruction of viewing. The temperature output can be adjusted to accommodate for warmer or cooler external environments. In cooler environments condensation becomes a larger problem, and these can easily stop this a being a nuisance. These glass heating elements may be attached to any glass surface forming the said enclosure, provided it is required to regulate the temperature of said glass surface to reduce surface condensation or regulate and maintain the temperature of the glass surface in order to retain the integrity of the environment, with consideration of direct contact by floral or faunal inhabitants of the system. There may be a plurality of said devices integrated into the system. The device may consist of an utra-this wire integrated in or on the surface of the glass, in a manner that effectively accomplishes temperature regulation of the glass. Said heating device is furthermore adjustable with respect to the temperature output and may be connected to the environmental computer.

(14) Sensory-Output microclimate control computer. A computer to control several microclimates within a single vivarium system. Further refines the ability of the system to replicate a natural biotope. This computer operates by a sensory response system, measuring environmental factors in the vivarium and adjusting devices to regulate the environment to fall within a preprogrammed range.

(15) Water filtration and maintenance is an automatic system that: Constantly controls the water level in the reservoirs. Automatically changes water in the system on a regular basis. This is a vital part of the invention as it reduces maintenance to a substantial degree. Normally a moderate to large size vivarium can lose 5 to 20 gallons of water per week by evaporation. This system reduces the backbreaking labor of carrying water to refill the reservoir. Also, it is normal to change ¼ to ½ of the water of the system every 2 weeks to 1 month. By means of a pump on a timer, with the tube leading to a drain, this system will change its own water, and refill by means of the automatic system. (Generally, a reverse osmosis prefilter is used, which leads to a reservoir with a float valve to control water level.

(16) Air Heating/Cooling interior fan. This fan is able to heat or cool the air, and responds to the sensory system via the Environmental Control Computer. It is also useful for moving warm air at the top of the vivarium to the bottom. It does not introduce fresh air into the system, but reduces stagnation of the environment by continually circulating the air, as defined by the computer.

All forms of the present invention must include items (1), (3), (4), (7), (8), (9), (10), (11), (12), and (15) these are generally considered as necessary to meet the environmental control requirements for all sizes and designs of the said invention. Together these systems work in unison, each balancing the other to create a unified working system to closely balance natural rainforest environments.

They may not all be necessary depending on other additions used, for example, it would not be necessary to use the lower ventilation plate as described in (1) if the vivarium has feature numbers (6) & (13). Other substitutive examples exist within the scope of this Item (10) is only required in instances where secondary plateaus within the vivarium assembly are too tall to allow for the maximum depth of substrate (6-10 inches).

Items (2), (5), (6), (13), (14) & (16) are optional depending on the size and the type of vivarium being produced, the external environment it is placed in and the conditions needed to be maintained within it.

Other Important Details:

At the top of the waterfall, the tube from the pump (located in the reservoir) is attached to a small pool with a rim lowered on one edge where the water is designed to flow down. This serves to slow the flow of water down to allow the water to fall from the rim as opposed to being propelled at a high velocity from the narrow tube. This allows large amounts of water to be delivered to the waterfall. In situations where a very large amount of water is to be delivered to the waterfall, the feed tube is first connected to a wider tube, which is then attached to the small pool. This feature allows the velocity of the water to be slowed down even further to prevent it from jetting up into the top glass of the vivarium.

Within the vivarium, separate devices to measure & record humidity & temperature fluctuations in various parts of the set-up can be installed to accurately recreate the jungle environment. To reduce or increase either of these environmental factors, the sliding ventilation adjustment plates and heaters located in the reservoir and Active Ventilation/Humidification assembly can be adjusted.

For complete maintenance-free accurate simulation of actual conditions within a natural rainforest throughout the different seasons each year, the system of electronic humidity/temperature sensors can be integrated with an assembly designed to automatically (motorized system) open and close the passive ventilation assembly. Furthermore, this motorized ventilation system, the misting system, and active humidification control can be connected to the same microcomputer. The microcomputer can be either integrated into the system, or an auxiliary home/office computer. This device can adjust systems (1), (2), (4), (5), (6), (23), (24), (29), (30), (33), (34), (43), (44), (53), (54), (61), (73), (75), (78), (82), (92), (93), & (94) in order to match the information from the sensors with values recorded in natural rainforests through seasonal transitions. Thus, the rainforest vivarium can automatically have cycles of rainy seasons and dry seasons.

For imitation of Sounds (birds, animals, thunder, etc.), a small speaker system that can be attached to a microcomputer or other device will enable the sounds of the rainforest to be played, thus further replicating the environment. This can be controlled at many levels, including the frequency of the sounds, as well as the volume. The sounds can be integrated into a daily and yearly cycle, as to mimic the actual sounds made in the rainforest throughout the year. Thus—different types of sounds will be heard in the morning, evening, before tropical storms, before a light misting, etc. Sounds will accompany the capabilities of both the aesthetic appeal of the vivarium, as well as the ability to closely mimic natural habitats.

For storm stimulation, a microcomputer is able to control the misting, lighting and fogging functions. The microcomputer is pre-programmed with different weather ‘themes’ and is able to incorporate the various functions of the vivarium to provide vivid environmental effects as found in nature. Thus, storms can be replicated, complete with heavy rain, thunder, animal sounds and calls, lightning flashes, etc.

It is possible to provide fogging. This function allows for a vivid display of fog moving through the rainforest. An Ultra-sonic fogger is connected to a separate mini-fogging-reservoir which has a fresh supply of filtered water fed directly from the main water supply. This is connected to a tube that runs up into the vivarium. When the fogging device is turned on, a flow of fog will travel up the tube, and then roll down the back of the vivarium, creating a vivid effect.

Automatic sliding doors are further provided. This feature allows the sliding doors to automatically open at the touch of a button. Generally, this feature is most relevant if connected to a remote control, allowing the user to display the device and it's capabilities.

The system can have a remote control. This is integrated with the environmental control computer and allows the user to control various functions of the vivarium. This will allow the user to initiate a tropical storm, turn on birds and wildlife sounds, dim the system, open the automatic sliding glass doors, etc. The remote control will allow the user to display all the capabilities of the unit without having to adjust any controls hidden underneath in the cabinet.

The system can include automatic feeding—insect breeding. This is a system designed to automatically feed insects to the vivarium animal inhabitants. It is most useful as it keeps the animal inhabitants fed when the owner is away. The system is used to breed flightless fruit flies, but can be used for other insects such as ‘ofenfischchen’ that are compatible with the system.

A lower breeding chamber, hidden below in the cabinet, is connected to a tube that leads into the vivarium, giving the insects an enclosed pathway to walk from the breeding area into the vivarium. In general, negatively geotropic insects must be used. The tube is clear, and illuminated; to further facilitate the movement of positively phototropic insects into the vivarium. The breeding chamber contains all the elements needed for reproduction of the insects. It is easily removable from the system, to allow for changing of the breeding materials. All components have watertight connections with the vivarium and are also escape proof, allowing for a sealed system. The insect breeding system may have ventilation areas, but they must prevent the escape of the insects. Several breeding chambers can be connected to the system, as in the case for fruit-flies, where they are bred in small plastic jars or cylinders, and the system can be designed so that several breeding jars can be easily connected to the system to ensure enough insect prey are present in the vivarium.

A living wall—heater/humidified air-curtain can be further provided. On large versions of our living wall, there is a specialized airflow barrier, known as an air curtain, which is a thin moving sheet of heated, humidified air that passes in the front of the enclosure (blown at an even rate from the bottom and is recollected at the top) and acts as an invisible barrier to keep the internal rainforest environment separated. This has the function of separating the environment of the living wall from the extewrnal environment without the need for glass. It is necessary because it reduces the need for excessive environmental controls to adjust humidity & temperature, and reduces the level of over-ventilation in the living wall system in order to better preserve the microclimates of the living wall system.

The inventive device can have a hydroponic substrate moistening system. This is necessary in situations where the wick system is unable to carry water to the substrate because the area being irrigated is too far from the water source to allow for capillary action to pull the water to the substrate, and in these areas the substrate may eventually dry out. In such cases, which are evident especially in large living wall systems, a pump in the main reservoir is connected to tubing which leads to these areas. The pump is on a timer and briefly waters these areas to maintain the moisture of the substrate. The timer may be replaced by an irrigation control valve, which may be connected to an environmental control computer or a timer, to control the irrigation cycle. This is used to divert water to irrigation tubing located in an organic substrate layer. Generally, only a few minutes per week are necessary, but this depends on the type & size of plants in the area of interest, temperature and humidity of the vivarium and the amount of light on the area of interest. The irrigation level can be adjusted to accommodate the watering needs. If all areas irrigated in this manner have different watering requirements but are connected to the same pump, the delivery ends of the tube are adjusted to reduce (or increase) the water volume being delivered to each area.

The invention includes of an enclosed structure that is able to precisely control and maintain the environmental conditions found in a natural tropical rainforest habitat. It has an upper environmental containment portion composed of glass, or both glass and acrylic, with a decorative cabinet built to surround and conceal the apparatus used to control the system.

The system contains a waterfall that is fed by a submersible pump located in a heated exterior water reservoir located in the lower cabinet, and is connected by watertight fittings passing through a hole drilled in the bottom of the vivarium assembly. The flow of water follows through an overflow valve in the vivarium, allowing an adjustable water level within the vivarium, yet another advantage as aquatic life can be easily added and the water level can be raised to suit this. After selecting the desired water level within the vivarium, it will remain constant, despite evaporation due to the overflow/reservoir feature, and water can be added, if needed, to the lower reservoir. The system can easily be integrated with a filter and float valve assembly connected to the lower reservoir, which allows it to be hooked into the existing household or building water line, giving the present invention a large benefit for the consumer as the water will never have to filled up, providing complete maintenance free watering of the vivarium.

The system also has a specialized misting system located in the lower cabinet that feeds misting nozzles located in the top portion of the vivarium. The top portion of the cabinet contains lights to illuminate the vivarium, as well as a grid that effectively hides the lights, wires and tubes from view when observed from any viewing angle. The top of the cabinet (or canopy) may or may not contain a hinged lid, but in all cases, there are openings to allow free passage of air. Ballasts for the lights, if necessary, are located in the lower cabinet, with wires running up to power the lights. The design has been modified significantly from standard patented terrariums/vivariums in order to accommodate the specific needs to maintain tropical rainforest climates. Several highly specific modifications have been incorporated that effectively eliminate all stagnation within the vivarium system, which differs substantially from traditional vivarium/terrarium designs, which easily become rather unsightly and stagnant within a short timeframe without regular maintenance.

The system consists of a front opening sliding glass double door assembly with two perforated metal ventilation strips incorporated into the structural design at the lower front end of the structure, perpendicular to the bottom of the sliding front door track assembly, and at the top of the structure. The lower ventilation strip, made of any perforated material with holes small enough to prevent the escape of organisms over 1/16″, must be located below the lateral access panel (front sliding door). The cabinet is accordingly vented at the bottom and the top to allow passive airflow in through the bottom of the rainforest vivarium and out through the top. This ventilation design allows for the front viewing glass to remain free of condensation, an unsightly problem in traditional terrariums. The ventilation strip must be located below the front viewing glass in order to retard condensation on the front viewing surface. This system of passive ventilation can be adjusted to achieve varying levels of humidity within the enclosure via thin sliding track incorporated into the structure, containing moveable glass. This glass is situated so that it moves in front of the ventilation plates, and thus can be adjusted to regulate airflow through the system via varying the area of the ventilation strip that is blocked by the sliding glass strip. This passive form of ventilation is an inexpensive and effective way to regulate humidity and condensation. This vital feature is necessary for maintaining a rainforest vivarium micro-ecosystem in different geographical locations. For example, to maintain a humidity of 90% in Arizona would require that the vents to be almost closed, while to maintain the same humidity within the vivarium in Hawaii would mean the vents can be left more open. Without this feature, the vivarium would be over-ventilated in Arizona, and under-ventilated in Hawaii. Further modifications of the ventilation system may be required depending on a) the size of the vivarium and b) the external temperature. These include Heating elements, which are used to heat the front viewing glass which will stop condensation. Another method to stop condensation on the viewing glass surface is to heat the ventilation strips, allowing the passive airflow to become active airflow, which is heated and then goes up the glass & out the top ventilation strip. Both features can be placed on a timer apparatus so that the glass remains decondensed during the daytime, and is allowed to fog up at night, which also replicates natural dew formation & increased humidity as in the rainforest.

A vital addition to the ventilation is an anti-splash drip guard.

The entire landmass and all plateaus within the landscape are situated on a false-bottom assembly, which consists of any sort of perforated rigid sheeting or mesh to allow for drainage, and further eliminates stagnation. All plateaus, or levels within the system are required to have a depth of substrate no greater than 6 to 10 inches, to maintain the integrity of the rainforest system. Thus, additional suspended false bottom assemblies are situated in all levels of the vivarium that exceed 6 to 10 inches above the false bottom apparatus. In order to maintain the integrity of the tropical plants, the substrate immediately on top of the false bottom assembly consists of Light Expanded Clay Aggregate (LECA), or other inorganic porous medium which effectively allows for uninhibited root growth and retards rotting of the upper substrate mixture, typically consisting of a mixture of orchid bark, charcoal, sand, soil, coconut husk, palm bark and peat moss in varying proportions.

The system consists of a primary waterfall assembly, which is engineered to fall over a waterfall-simulating structure consisting of mainly of either cork-bark or artificial rock, with accompanying decorative wood and rocks. The waterfall assembly is highly unique because the main pump, which is located in the reservoir in the cabinet below the vivarium, leads to a valve that directs some water to a ring of perforated plastic tubing that is run around the perimeter of the bottom of the vivarium assembly. This enables a constant flow of fresh heated and oxygenated water throughout the bottom of the assembly, preventing stagnation. The present invention also contains a wick system that connects the false bottom to the thin layer of water at the bottom of the enclosure provides a steady temperature regulation of the substrate within the enclosure, and consists of thin pieces of nylon or other fabric that touches the bottom or is connected to it, and passes up into the false bottom assembly to touch the inorganic layer. This warm freshly oxygenated water also aids the ambient air temperature simulating natural tropical rainforest habitats. The rear and side walls of the rainforest vivarium may consist of tree-fern root or panels made of pressed coconut fibre, in order to allow tropical plants, mosses and vines to grow on and cover these surfaces. In this case, the waterfall assembly is extended to perforated tubing placed above these panels to allow the panels to be kept moist, allowing uninhibited growth of plants. An additional valve maintains the water pressure equally at all holes along the perforated tubing. This system poses an additional advantage as a filter, in case tropical wildlife such as amphibians, reptiles or fish are kept in the enclosure. This feature allows the system to encompass the true nature of a self sustaining rainforest vivarium as nitrate and toxic ammonia levels are kept equally low as they are in nature, as the plants are constantly actively filtering the continual flow of water passing by their roots in the vertical irrigated panels. This also provides an additional level of revitalization of the humidity and freshness of the ambient air, as the heat, humidity and oxygen is transpired from the plants growing in the irrigated panels to the enclosed atmosphere. The metabolism of the plants in the side and or back panels is thus also pushed to levels mimicking natural rainforest environments, thus increasing oxygen output and the pristine maintenance of the system, which is predominantly important in larger rainforest vivariums with a larger contained atmosphere. In systems where the vivarium glass/acrylic case is taller than 36 inches two pumps are generally used, one for the waterfall and another for the perforated tube irrigation assembly.

It is important to note that the entire vivarium may consist of 360 degrees of viewing surfaces, or on some cases, all surfaces may be open for viewing except the bottom, with the landmass in the middle. A conbination of ventilation and heated glass can be used to stop condensation on all viewing surfaces.

Another option for maintenance of control of fresh air supply underneath the primary and secondary waterfall assemblies involves additional air fed to this part of the enclosure via tubes through a watertight connection from the lower cabinet area. An air pump passes outside air into the bottom of the assembly into a ring of perforated tubing, creating a bubbling action in the water below the false bottom assembly. Another version of this forced ventilation can include humidification. This forced ventilation system utilizes an electric air pump, with tubing that leads to a bubbler located in a sealed unit filled with water, and has a heater to regulate humidity. The water level in the sealed unit can be maintained by a float valve. Another tube is located in this sealed assembly and is passed into the vivarium.

2. One modification to this specific rainforest system where the bottom portion has been modified to contain a larger aquatic environment, and the overflow valve is thus positioned to allow a larger amount of water to accumulate in the lower portion. An external reservoir is used to maintain water level, as the pump and misting system are run from two separate external reservoirs situated in the lower cabinet. At the water/air interface level between the aquarium and vivarium portions, there consists a sealed glass housing incorporated into the design which allows for placement of an additional light to illuminate the aquarium, this is concealed by a back wall housing comprised of artificial rock or other material (organic or inorganic). The Vivarium portion will have the same upper features and structural design as in (1) but it must contain an irrigated panel on the sides and/or back wall of the enclosure for filtration purposes. All water from the aquarium is fed back to the external reservoir that contains the heater & pumps. Thus, the waterfall leads into the vivarium, typically passes down a small streambed and down a smaller waterfall into the aquarium portion, and then down a tube/water-level back into the lower reservoir. To replace a passive frontal ventilation panel for aesthetic appeal to eliminate condensation on the viewing surface, the upper vivarium may have an active system consisting of an electric air pump fed series of tubes that effectively directs fresh air at the front glass. The tubes may be placed in the substrate and aimed at the glass or can be connected to an aeration strip that blows the air up the front viewing surface. The other option to stop condensation on the viewing surfaces is to have a combination of a small horizontal ventilation plate combined with heating elements to heat the front viewing surfaces. The slim ventilation plate is adjustable, and can be heated to allow active airflow.

3. A third modification is a much larger living wall assembly, which has identical structural features of either (1) or (2) but does not require the use of glass doors in the front of the assembly, and the tropical environment is maintained by a cycle of misting and humidification. These systems typically have a high ratio of irrigated surface area, to encourage maximum distribution of heat and oxygenation within the growing substrate to equate its own microclimate to natural rainforest conditions. This system can incorporate a larger aquatic area to include fish, aquatic plants and other aquatic animals.

One of the most important modifications that can be added to any of the three modifications of the vivarium system is able to turn the vivarium into a perfect replica of any natural biotope. All three systems can be modified with a computer controlled environmental regulation system. This system can be made to perform a number of tasks including both simple and complex feedback sensory functions. The most useful of which is to have sensors located at various parts of the vivarium to record temperature, humidity, and any other environmental factors and upload the collected data to the computer, which is pre-programmed to maintain certain humidity, temperature, light, nutrient etc. levels in each sensory area. Then with the sensor data, controls are adjusted by the computer that will increase or decrease misting, heating, lighting in that area. Thus, large ecosystems can be maintained and within themselves have controlled areas that are drier, wetter, rainier, boggier etc. all automatically based on this sensor-feedback system. The computer can be programmed to maintain actual values from nature by inputting daily fluctuations as recorded in a natural biotope. Thus, combining computer sensory-feedback technology with real environmental data, a biotope can be replicated. As in nature, biotopes have many microclimates within them, combinations of wet, sunny, shady, warm, cool, dry and other areas all located together. To increase the diversity of microclimates within the system, the design can then increase the number of sensors and more responsive controls for misting, temperature boosting & cooling and humidification. The implications of this part of the invention are highly useful for zoos and other organizations wishing to preserve endangered life in captivity, as the pristine habitat of the endangered animal or plant can be replicated down to the exact hourly, daily and annual environmental fluctuations, and maintained even after the habitat it simulates has disappeared from nature. Instead of a single temperature, humidity etc. for the entire vivarium, multiple values can be maintained throughout, as in nature, simulating various different microclimates within the same area.

In both (1) and (2) submersible water pumps are always situated in a lower cabinet assembly.

In (1), (2) and (3), the water supply in the reservoir is heated with a submersible heater to replicate the specific needs of the rainforest & its inhabitants. There may also be an aeration device to increase aeration of the water above the level that is already increased by the waterfall, if necessary.

It will be understood that each of the elements described above, or two or more together, may also find a useful application in other types of constructions differing from the types described above.

While the invention has been illustrated and described as embodied in self-contained tropical rainforest vivarium system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A self contained tropical rainforest vivarium system, comprising an enclosure; and means for creating and maintaining environmental conditions found in a natural tropical rainforest habitat, which at the same time eliminate unnecessary build-up of anaerobic bacteria so as to prevent accumulation of stench and resulting need for frequent disassembly for cleaning and removal of the bacteria and contaminants.

2. A self contained tropical rainforest vivarium system as defined in claim 1, wherein said means include means for providing a controlled entry of external air so as to provide a simultaneous control over humidity and ventilation and to eliminate condensation due to low exterior temperatures.

3. A self contained tropical rainforest vivarium system as defined in claim 1, wherein said means include a substrate; and a drainage mechanism for keeping said substrate aerated and warm to recreate highly humid and warm conditions of a rainforest.

4. A self contained tropical rainforest vivarium system as defined in claim 1; and further comprising an aquarium portion, said means including means for accurately recreating an ambient microclimate of a tropical rainforest, with controlling aeration of said substrate and maintaining a balance between humidification of an environment and an effective control over fresh air intake.

5. A self contained tropical rainforest vivarium system as defined in claim 4, wherein said means include means for creating a functional self-contained irrigation system with plants effectively removing and filtering out wastes produced by aquatic inhabitants of an aquarium portion.

6. A self contained tropical rainforest vivarium system as defined in claim 4; and further comprising a lighting panel operative for lighting of aquarium portion.

7. A self contained tropical rainforest vivarium system as defined in claim 4; and further comprising a heating panel operative for heating said front viewing glass surfaces.

8. A self contained tropical rainforest vivarium system as defined in claim 1, wherein said means include adjustable passive ventilation plates provided with slidable panels for regulating humidity within a controlled reinforcing environment, so as to initiate an airflow through a bottom vent, which follows up a front viewing surface through an upper ventilation plate, to prevent condensation of the viewing surface, to allow fresh intake of air, and to provide regulation of environmental conditions based on an exterior environment.

9. A self contained tropical rainforest vivarium system as defined in claim 4, wherein said means further includes means for heating said plates for increasing active airflow.

10. A self contained tropical rainforest vivarium system as defined in claim 1, wherein said means includes a waterfall assembly with a waterfall fed from a pump located in an externally heated reservoir.

11. A self contained tropical rainforest vivarium system as defined in claim 9; and further comprising an overflow valve through which said external heated reservoir is fed so as to create a recirculation aquatic system.

12. A self contained tropical rainforest vivarium system as defined in claim 1, wherein said means include an irrigation/stagnation assembly including a perforated tube providing water in a ring assembly which irrigates a bottom panel of said enclosure, fed from a pump located in an external reservoir which in turn is fed from an overflow valve, which is a part of a recirculating aquatic system.

13. A self contained tropical rainforest vivarium system as defined in claim 4, wherein said means include an irrigation/stagnation assembly including a perforated tube providing water in a ring assembly which irrigates a bottom panel of said enclosure, fed from a pump located in an external reservoir which in turn is fed from an overflow valve, which is a part of a recirculating aquatic system.

14. A self contained tropical rainforest vivarium system as defined in claim 11, wherein said means include a waterfall with a waterfall pump and a separate valve connected to said irrigation/stagnation assembly to balance a pressure between said waterfall and said assembly so as to maintain an ambient temperature of a bottom of said enclosure and to aerate for a continuous flow of all water to prevent stagnation.

15. A self contained tropical rainforest vivarium system as defined in claim 12, wherein said include a panel irrigation assembly including a perforated tube means providing water to ring assembles to irrigate vertical growth substrate panels of said enclosure, and fed from a pump located in an external reservoir.

16. A self contained tropical rainforest vivarium system as defined in claim 1, wherein said means include an active ventilation/humidification assembly including an air pump pumping fresh air into a sealed unit filled at least partially with water, so as to aerate an air space under a false bottom assembly and humidify air.

17. A self contained tropical rainforest vivarium system as defined in claim 1, wherein said means include a misting system, with a pump for delivering a controlled misting cycle.

18. A self contained tropical rainforest vivarium system as defined in claim 1; and further comprising a false bottom assembly including a plate provided with a plurality of openings for supporting a land mass and a substrate within said enclosure and at the same time allowing full drainage through said substrate.

19. A self contained tropical rainforest vivarium system as defined in claim 18; and further comprising a wick system which passively irrigates said substrate located on said false bottom assembly with water fed from an active irrigation assembly.

20. A self contained tropical rainforest vivarium system as defined in claim 1; and further comprising a false bottom and a substrate located on said false bottom and consisting of 75-100% of porous inorganic matter layered on top of primary and secondary false bottom assemblies.

21. A self contained tropical rainforest vivarium system as defined in claim 20; and further comprising an organic substrate placed on top of said inorganic substrate and including a mixture of organic components.

22. A self contained tropical rainforest vivarium system as defined in claim 1; and further comprising decondensation glass heating elements attached to a glass viewing surface of said enclosure and heating the latter so as to stop condensation and obstruction of viewing, and control means for controlling a heating temperature to accommodate various environments.

23. A self contained tropical rainforest vivarium system as defined in claim 1, wherein said means include computer means for controlling a microclimate within said enclosure and refining ability to replicate a natural biotope.

24. A self contained tropical rainforest vivarium system as defined in claim 1, wherein said means include means for water filtration and maintenance formed as an automatic system which constantly controls water level and automatically changes water on a regular basis.

25. A self contained tropical rainforest vivarium system as defined in claim 1; and further comprising means enabling sounds of rainforest to be played, and including speaker means and means for adjusting the sounds in a cyclical fashion.

26. A self contained tropical rainforest vivarium system as defined in claim 23; and further comprising means for simulating a storm by replicating parameters selected from the group consisting of heavy rain, thunder, animal sounds and calls and lightening flashes.

27. A self contained tropical rainforest vivarium system as defined in claim 1; and further comprising means for producing a fog moving through a rainforest in said enclosure, including means for providing a fresh supply of water.

28. A self contained tropical rainforest vivarium system as defined in claim 1; and further comprising a sliding door; and means for automatically opening and closing of said sliding door.

29. A self contained tropical rainforest vivarium system as defined in claim 1; and further comprising remote control means operative for remotely controlling by a user various parameters of an environment inside said enclosure.

30. A self contained tropical rainforest vivarium system as defined in claim 1; and further comprising means for breeding insects and automatically feeding, and automatically feeding the breed insects into an interior of said enclosure for feeding animal inhabitants of said enclosure.

31. A self contained tropical rainforest vivarium system as defined in claim 1; and further comprising an air flow barrier formed as an air curtain for separating of an interior of said enclosure from an external environment.

32. A self contained tropical rainforest vivarium system as defined in claim 1; and further comprising an air flow barrier comprised of air of controlled temperature and humidity formed as an air curtain for separating of an interior of said enclosure from an external environment.

33. A self contained tropical rainforest vivarium system as defined in claim 1; and further comprising a substrate, and a hydroponic substrate moistening system for moistening said substrate.

34. A self contained tropical rainforest vivarium system as defined in claim 1; and further comprising a heating and cooling fan for maintaining desired temperatures.
